(19) United States
(12) Patent Application Publication
(10) Pub. No.: US 2026/0041108 A1
(43) Pub. Date: Feb. 12, 2026

(54) ESSENTIAL OIL BLENDS FOR POTATO SPROUT CONTROL IN STORAGE

(71) Applicant: Oregon State University, Corvallis, OR (US)

(72) Inventor: Valtcho D. Jeliazkov, Corvallis, OR (US)

(73) Assignee: Oregon State University, Corvallis, OR (US)

(21) Appl. No.: 19/271,254

(22) Filed: Jul. 16, 2025

Related U.S. Application Data
(60) Provisional application No. 63/672,557, filed on Jul. 17, 2024.

(51) Int. Cl. A23B 7/154

(52) U.S. Cl. CPC A23B 7/154

(57) ABSTRACT

Essential oil blends for suppressing potato sprouts. Blend A includes Lavandula angustifolia essential oil; Lavandula angustifolia and Salvia sclarea co-extract essential oil; and Gaultheria fragrantissima essential oil. Blend B includes Gaultheria fragrantissima essential oil; and Coriandrum sativum essential oil. Blend C includes Carum carvi CO₂ extracted essential oil; Cymbopogon martinii essential oil; Aniba rosaeodora essential oil; and Prunus armeniaca essential oil. Blend D includes Cymbopogon martinii essential oil; Citrus aurantium subsp. bigaradia essential oil; Aniba rosaeodora essential oil; and Prunus armeniaca essential oil. Blend E includes Carum carvi essential oil; Cymbopogon martinii essential oil; Citrus aurantium subsp. bigaradia essential oil; Aniba rosaeodora essential oil; and Prunus armeniaca essential oil.

### CROSS REFERENCE TO RELATED APPLICATION

This application claims the benefit of U.S. Provisional Application No. 63/672,557, filed Jul. 17, 2024, which is incorporated herein by reference.

### ACKNOWLEDGMENT OF GOVERNMENT SUPPORT

This invention was made with government support under 2021-51106-35584 awarded by U.S. Department of Agriculture, National Institute of Food and Agriculture. The government has certain rights in the invention.

### BACKGROUND

Potato (Solanum tuberosum L.) is the most important non-cereal staple crop in the world and is a main contributor towards improving food security and reducing hunger. In 2022, 375 million tons of potatoes were produced globally, with the U.S. producing 17.8 million tons, and Canada 6.2 million tons (FAOSTA, 2022), and the number is projected to grow considerably (Gumbo et al., 2021). In 2023, potato production increased and reached approximately 440.75 million cwt in the US (Shahbandeh, 2024). The total value of exported potatoes from the U.S. in 2017 was around $3.0 billion (NASS, 2018). However, most of the potatoes (up to 70%) produced in the U.S. is stored.

Dormancy is a physiological condition in which plants respond to stresses by entering into a state of growth suspension. The dormancy period in potato is characterized by absence of visible growth of buds (sprouts) and is under environmental, physiological and hormonal control. Extended dormancy is desirable and important in potato storage and for providing consistent potato supply for the market and the processing industry.

Sprouting in potato occurs when dormancy is broken. Control of sprouting is critical for potato storage since the sprouting leads to alterations in weight, texture, nutritional value, softening, shrinkage, and formation of toxic alkaloids. For long-term storage of potatoes (up to 9 months), storage at 8-12° C. with 85-90% relative humidity (RH) is the most appropriate method. However, once the natural dormancy period of the tuber is over, this storage temperature of 8-12° C. is favorable for sprouting and sprout growth. Cold temperature storage will also alter sugar content, primarily glucose. Higher concentrations of glucose cause products to fry dark resulting in unacceptable potato product color. Therefore, the use of a potato sprout suppressant is essential.

The primary methods for controlling sprouting of stored potatoes is by using sprout inhibiting chemicals that are effective; however, they not allowed in certified organic production. To extend the storage period in conventional production, growers in the U.S. and around the world have been using chlorpropham (CIPC, isopropyl 3-chlorocarbanilate), maleic hydrazide and other sprout inhibitors and by controlling external factors such as temperature, humidity, and the composition of the gases in the storage facility. Chlorpropham (CIPC) is the most efficient and cost effective; however, research has shown that CIPC and its degradation products are hazardous for consumer health and the environment. Chlorpropham (CIPC) has a very long-lasting residue (crystallizes in storage) in the environment and in potato and various potato products.

The US Environmental Protection Agency classifies CIPC as a plant growth regulator and herbicide. CIPC is the most widely used sprout suppressant in the last few decades; it was reported that “90% of all potato sprout suppressant applications in 2020 included CIPC in their mixtures”.

During fogging application in stored potatoes, the thermal degradation of CIPC leads to the production of 3-chloroaniline (3-CA), a hazardous compound that specifically affects the hematopoietic and renal systems (Arena et al., 2017). 3-CA is also produced by digestive activity when ingested by mammals, making CIPC residues potentially hazardous to humans (Boivin et al., 2020). While there isn't direct evidence linking 3-CA to carcinogenicity, its structural resemblance to 4-CA, a confirmed carcinogen and genotoxin, raises significant concerns (Thoma and Zheljazkov, 2021).

Both the USA and international legislation have imposed limitations on CIPC for sprout suppression. In the United States, the Food Quality Protection Act of 1996 reduced the permissible CIPC residue on fresh potatoes from 50 ppm to 30 ppm. While 30 ppm remains effective for extended sprout suppression, more stringent proposals in the UK advocating for a limit of 5 ppm might struggle to ensure suppression beyond four months without the need for additional applications [Kleinkopf et al., 2003]. Furthermore, the European Union (EU) implemented a complete ban on CIPC, with the final utilization of CIPC products concluding in 2020.

Chemical suppressors are prohibited in certified organic production and processing. Therefore, CIPC cannot be utilized for storage of organic potatoes.

Growers and processors around the world have been applying essential oil-based products. Illustrative commercially available products include spearmint (Mentha spicata L.,), orange (Citrus x sinensis (L.) Argos®), caraway (Carum carvi L., Talent®), and clove (Syzygium aromaticum (L., Biox-C). However, of these, only Biox-C(clove essential oil) is registered in the United States.

### SUMMARY

Disclosed herein are essential oil blends for suppressing potato sprouts.

Blend A includes Lavandula angustifolia essential oil; Lavandula angustifolia and Salvia sclarea co-extract essential oil; and Gaultheria fragrantissima essential oil. Blend B includes Gaultheria fragrantissima essential oil; and Coriandrum sativum essential oil. Blend C includes Carum carvi CO₂ extracted essential oil; Cymbopogon martinii essential oil; Aniba rosaeodora essential oil; and Prunus armeniaca essential oil. Blend D includes Cymbopogon martinii essential oil; Citrus aurantium subsp. bigaradia essential oil; Aniba rosaeodora essential oil; and Prunus armeniaca (bitter almond) essential oil. Blend E includes Carum carvi essential oil; Cymbopogon martinii essential oil; Citrus aurantium subsp. bigaradia essential oil; Aniba rosaeodora essential oil; and Prunus armeniaca essential oil.

In one aspect, blend A includes:
5 to 40 vol %, more particularly 18 vol %, Lavandula angustifolia essential oil;
5 to 40 vol %, more particularly 15 vol %, Lavandula angustifolia and Salvia sclarea co-extract essential oil; and
30 to 90 vol %, more particularly 67 vol %, Gaultheria fragrantissima essential oil, based on the total volume of the composition.

In certain embodiments, Lavandula angustifolia essential oil, Lavandula angustifolia and Salvia sclarea co-extract essential oil, and Gaultheria fragrantissima essential oil are the only essential oils present in blend A.

In one aspect, blend B includes:
30 to 95 vol %, more particularly 78 vol %, Gaultheria fragrantissima essential oil; and
5 to 55 vol %, more particularly 22 vol %, Coriandrum sativum essential oil,
based on the total volume of the composition.

In certain embodiments, Gaultheria fragrantissima essential oil and Coriandrum sativum essential oil are the only essential oils present in blend B.

In one aspect, blend C includes:
4 to 55 vol %, more particularly 25% vol %, Carum carvi (carraway) CO₂ extracted essential oil;
5 to 50 vol %, more particularly 25% vol %, Cymbopogon martinii (palmarosa) essential oil;
5 to 45 vol %, more particularly 25% vol %, Aniba rosaeodora (rosewood) essential oil; and 5 to 55 vol %, more particularly 25% vol %, Prunus armeniaca (bitter almond) essential oil,
based on the total volume of the composition.

In certain embodiments, Carum carvi (carraway) CO₂ extracted essential oil, Cymbopogon martinii (palmarosa) essential oil, Aniba rosaeodora (rosewood) essential oil, and Prunus armeniaca (bitter almond) essential oil are the only essential oils present in blend C.

In one aspect, blend D includes:
6 to 50 vol %, more particularly 25% vol %, Cymbopogon martinii (palmarosa) essential oil;
5 to 50 vol %, more particularly 25% vol %, Citrus aurantium subsp. bigaradia (neroli) essential oil;
5 to 45 vol %, more particularly 25% vol %, Aniba rosaeodora (rosewood) essential oil; and
5 to 55 vol %, more particularly 25% vol %, Prunus armeniaca (bitter almond) essential oil,
based on the total volume of the composition.

In certain embodiments, Cymbopogon martinii (palmarosa) essential oil, Citrus aurantium subsp. bigaradia (neroli) essential oil, Aniba rosaeodora (rosewood) essential oil, and Prunus armeniaca (bitter almond) essential oil are the only essential oils present in blend D.

In one aspect, blend E includes:
4 to 55 vol %, more particularly 20% vol %, Carum carvi (carraway) essential oil;
6 to 50 vol %, more particularly 20% vol %, Cymbopogon martinii (palmarosa) essential oil;
6 to 45 vol %, more particularly 20% vol %, Citrus aurantium subsp. bigaradia (neroli) essential oil;
5 to 45 vol %, more particularly 20% vol %, Aniba rosaeodora (rosewood) essential oil; and
6 to 55 vol %, more particularly 20% vol %, Prunus armeniaca (bitter almond) essential oil,
based on the total volume of the composition.

In certain embodiments, Carum carvi (carraway) essential oil, Cymbopogon martinii (palmarosa) essential oil, Citrus aurantium subsp. bigaradia (neroli) essential oil, Aniba rosaeodora (rosewood) essential oil, and Prunus armeniaca (bitter almond) essential oil are the only essential oils present in blend E.

The foregoing will become more apparent from the following detailed description.

### BRIEF DESCRIPTION OF THE DRAWINGS

FIGS. 1A-1D are tables listing volatiles detected in eight different essential oils.

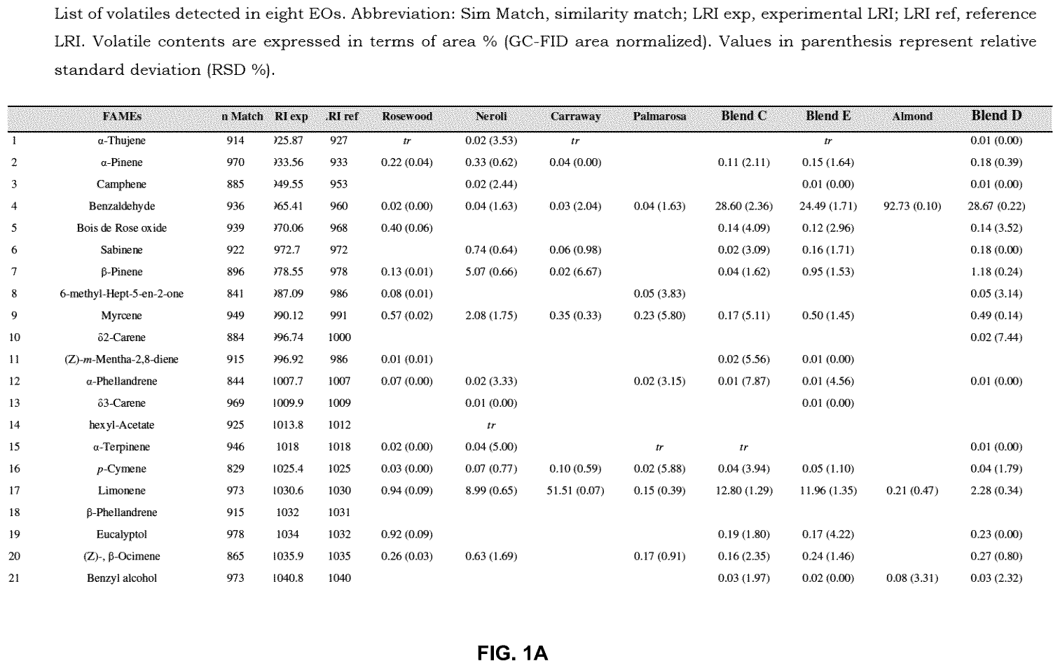

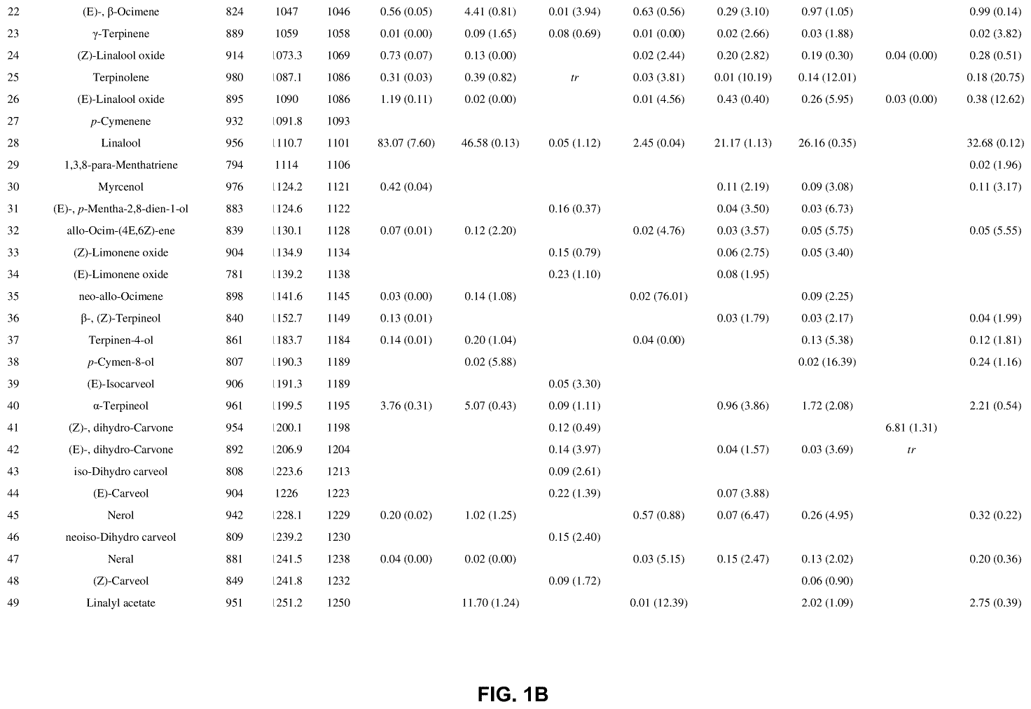

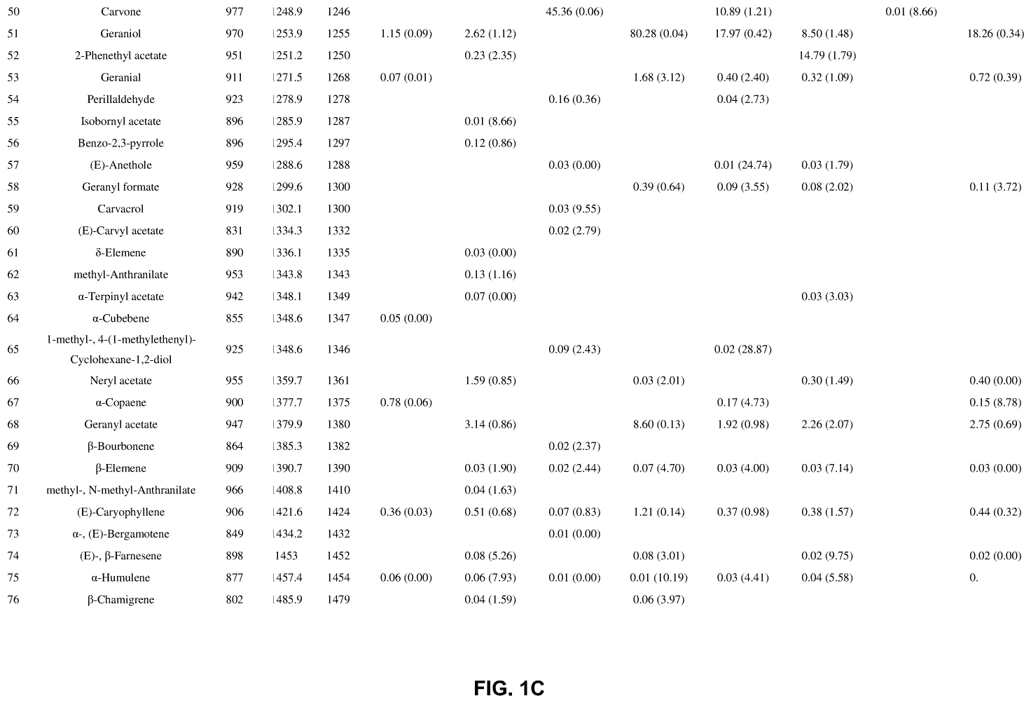

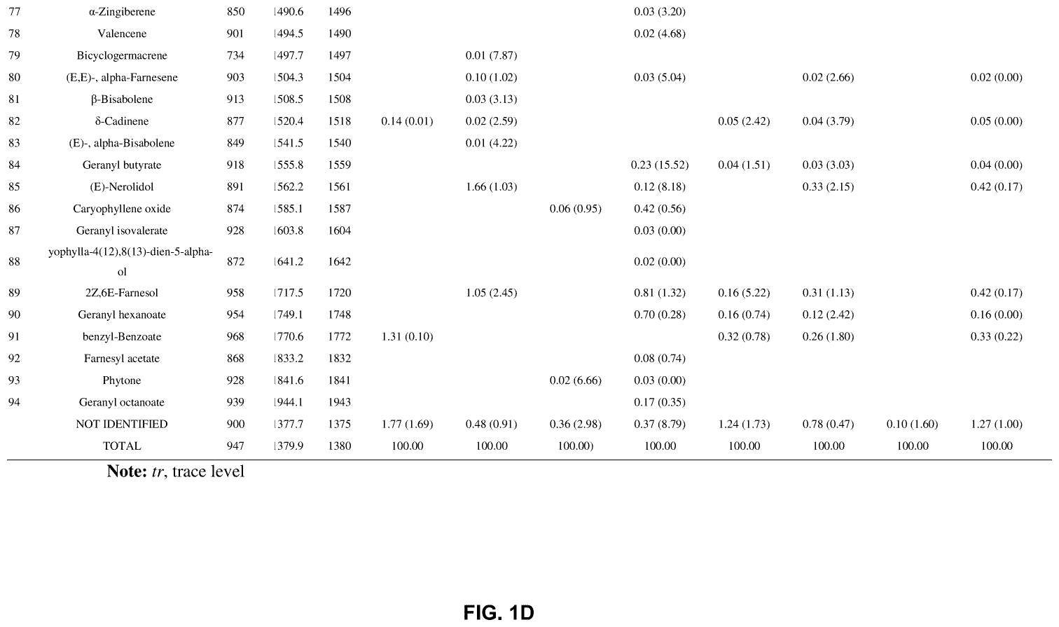

### DETAILED DESCRIPTION

One component of blend A is Lavandula angustifolia essential oil. In certain examples, the L. angustifolia is a variety from Bulgaria. In certain embodiments, the L. angustifolia is extracted via steam distillation. In certain embodiments, the L. angustifolia extract includes 5 to 55, more particularly 20 to 40 wt % linalool, 10 to 60, more particularly 20 to 40 wt % linalyl acetate, 0.5 to 30, wt % cis-, β-Ocimene, 0.5 to 30, more particularly 4.65 wt % trans-, β-Ocimene, 1 to 45, more particularly 4.22 wt % lavandulyl acetate, and 1 to 20, more particularly 3.41 wt % trans-, β-farnesene, based on the total weight of the Lavandula angustifolia essential oil.

Table 1 below lists the compounds found in an example of L. angustifolia (Brestak variety) essential oil.

TABLE 1
Identity of the volatile fraction contained
in Lavandula angustifolia Brestak EOs.

| | | MS | LRI | LRI | Area | RSD |
|---|---|---|---|---|---|---|
| ID | Compounds | Sim % | exp | lib | % | (%) |
| 1 | Diola | 97 | 822 | 821 | 0.03 | 0.00 |
| 2 | Tricyclene | 93 | 923 | 923 | 0.04 | 0.00 |
| 3 | α-Thujene | 97 | 926 | 927 | 0.13 | 0.90 |
| 4 | α-Pinene | 97 | 933 | 933 | 0.35 | 0.17 |
| 5 | Camphene | 97 | 950 | 953 | 0.34 | 0.34 |
| 6 | Sabinene | 96 | 973 | 972 | 0.04 | 1.55 |
| 7 | β-Pinene | 88 | 978 | 978 | 0.24 | 0.24 |
| 8 | Vinyl amyl carbinol | 90 | 979 | 978 | | |
| 9 | Octan-3-one | 96 | 984 | 986 | 0.63 | 0.27 |
| 10 | Myrcene | 96 | 989 | 991 | 1.12 | 0.24 |
| 11 | butyl-Butanoate | 98 | 995 | 999 | 0.05 | 1.15 |
| 12 | Octan-3-ol | 98 | 997 | 999 | 0.08 | 1.43 |
| 13 | α-Phellandrene | 94 | 1007 | 1007 | 0.07 | 0.84 |
| 14 | δ-3-Carene | 96 | 1009 | 1009 | 0.47 | 0.25 |
| 15 | hexyl-Acetate | 98 | 1012 | 1012 | | |
| 16 | α-Terpinene | 97 | 1018 | 1018 | 0.08 | 1.49 |
| 17 | o-Cymene | 90 | 1020 | 1024 | 0.09 | 1.11 |
| 18 | p-Cymene | 95 | 1025 | 1025 | 0.32 | 0.18 |
| 19 | Limonene | 95 | 1030 | 1030 | 0.43 | 1.22 |
| 20 | β-Phellandrene | 94 | 1031 | 1031 | 1.20 | 0.43 |
| 21 | Eucalyptol | 91 | 1033 | 1032 | | |
| 22 | cis-, β-Ocimene | 91 | 1036 | 1035 | 7.27 | 0.14 |
| 23 | trans-, β-Ocimene | 97 | 1046 | 1046 | 4.65 | 0.06 |
| 24 | γ-Terpinene | 96 | 1059 | 1058 | 0.22 | 0.46 |
| 25 | cis-Sabinene hydrate | 90 | 1071 | 1069 | 0.09 | 0.62 |
| 26 | Terpinolene | 95 | 1087 | 1086 | 0.18 | 0.00 |
| 27 | p-Cymenene | 90 | 1092 | 1093 | 0.04 | 0.00 |
| 28 | Linalool | 98 | 1101 | 1101 | 28.22 | 0.06 |
| 29 | 3-acetoxy-Octene | 96 | 1107 | 1109 | 0.82 | 0.07 |
| 30 | 3-octyl-Acetate | 94 | 1119 | 1120 | 0.05 | 1.22 |
| 31 | cis-, p-Menth-2-en-1-ol | 88 | 1126 | 1124 | tr | - |
| 32 | (4-trans, 6-cis)- | 88 | 1129 | 1128 | 1.46 | 0.14 |
| | Allocimene | | | | | |
| 33 | hexyl-Isobutyrate | 96 | 1146 | 1150 | 0.03 | 3.89 |
| 34 | Camphor | 98 | 1149 | 1149 | 0.36 | 0.32 |
| 35 | Lavandulol | 96 | 1165 | 1165 | 1.06 | 0.24 |
| 36 | Borneol | 99 | 1175 | 1173 | 1.01 | 0.11 |
| 37 | Terpinen-4-ol | 93 | 1183 | 1184 | 5.01 | 0.06 |
| 38 | p-Cymen-8-ol | 92 | 1189 | 1189 | 0.18 | 1.98 |
| 39 | Cryptone | 91 | 1190 | 1187 | | |
| 40 | hexyl-Butyrate | 95 | 1191 | 1195 | 0.28 | 0.88 |
| 41 | α-Terpineol | 97 | 1197 | 1195 | 1.60 | 0.24 |
| 42 | trans-Carveol | 94 | 1222 | 1223 | 0.02 | 3.33 |
| 43 | Nerol | 97 | 1226 | 1229 | 0.24 | 0.94 |
| 44 | Bornyl formate | 97 | 1231 | 1230 | 0.07 | 1.43 |
| 45 | hexyl-, 3-methyl- | 86 | 1235 | 1243 | 0.02 | 3.53 |
| | Butanoate | | | | | |
| 46 | Cuminaldehyde | 98 | 1245 | 1243 | 0.08 | 6.22 |
| 47 | Carvone | 91 | 1247 | 1246 | 0.04 | 8.65 |
| 48 | Linalyl acetate | 98 | 1251 | 1250 | 24.80 | 0.04 |
| 49 | Geraniol | 97 | 1254 | 1255 | 0.64 | 1.18 |
| 50 | Isopulegyl acetate | 87 | 1272 | 1273 | 0.03 | 5.15 |
| 51 | Phellandral | 97 | 1281 | 1277 | 0.04 | 7.73 |
| 52 | Lavandulyl acetate | 98 | 1284 | 1284 | 4.22 | 0.35 |
| 53 | Bornyl acetate | 98 | 1286 | 1285 | 0.23 | 8.26 |
| 54 | α-Terpinen-7-al | 87 | 1290 | 1287 | 0.01 | 6.66 |
| 55 | p-Cymen-7-ol | 95 | 1294 | 1291 | 0.02 | 8.81 |
| 56 | hexyl-Tiglate | 94 | 1329 | 1329 | 0.02 | 2.55 |
| 57 | cis-Geranyl acetate | 98 | 1359 | 1361 | 0.54 | 0.11 |
| 58 | trans-Geranyl acetate | 97 | 1378 | 1380 | 0.97 | 0.10 |
| 59 | hexyl-Hexanoate | 96 | 1385 | 1390 | 0.05 | 3.90 |
| 60 | 7-epi-Sesquithujene | 95 | 1388 | 1387 | 0.07 | 1.37 |
| 61 | α-Funebrene | 94 | 1403 | 1403 | 0.03 | 8.45 |
| 62 | cis-, α-Bergamotene | 97 | 1415 | 1416 | 0.05 | 1.25 |
| 63 | α-Santalene | 96 | 1421 | 1418 | 4.42 | 0.05 |
| 64 | trans-Caryophyllene | 99 | 1423 | 1424 | | |
| 65 | β-Copaene | 91 | 1433 | 1433 | 0.01 | 4.56 |
| 66 | trans-, α-Bergamotene | 97 | 1435 | 1432 | 0.14 | 0.00 |
| 67 | α-Himachalene | 89 | 1446 | 1449 | 0.04 | 2.79 |
| 68 | epi-, β-Santalene | 90 | 1449 | 1446 | 0.03 | 0.00 |
| 69 | trans-, β-Farnesene | 97 | 1454 | 1452 | 3.41 | 0.05 |
| 70 | α-Humulene | 95 | 1459 | 1454 | 0.12 | 5.29 |
| 71 | cis-Muurola-4(14),5-diene | 93 | 1466 | 1466 | 0.01 | 7.14 |
| 72 | Germacrene D | 95 | 1484 | 1480 | 0.28 | 0.36 |
| 73 | trans-, β-Bergamotene | 91 | 1486 | 1483 | 0.05 | 2.28 |
| 74 | trans, trans-, | 95 | 1505 | 1504 | 0.03 | 10.18 |
| | α-Farnesene | | | | | |
| 75 | β-Bisabolene | 96 | 1509 | 1508 | 0.04 | 8.57 |
| 76 | γ-Cadinene | 97 | 1517 | 1512 | 0.16 | 2.55 |
| 77 | Caryophyllene oxide | 96 | 1587 | 1587 | 0.19 | 0.53 |
| 78 | α-Muurolol | 91 | 1646 | 1651 | 0.07 | 6.05 |

| | | | | | |
|---|---|---|---|---|---|
| Not identified | — | — | — | 0.61 | 3.11 |
| Total | — | — | — | 100.00 | — |

Abbreviations: LRI exp: experimental LRI; LRI ref: reference LRI; MS Sim %: database spectral similarity; RSD: relative standard deviation. The volatile compounds are expressed in % values.
tr: trace level

Another component of blend A is a co-extract essential oil of Lavandula angustifolia and Salvia sclarea. A mixture of L. angustifolia and S. sclarea plant material is simultaneously distilled via steam distilling to obtain the co-extract essential oil. In certain embodiments, the L. angustifolia/S. sclarea co-extract includes 5 to 60, more particularly 18 to 20 wt % linalool, 5 to 55, more particularly 12 to 13 wt % linalyl acetate, 0.5 to 15, more particularly 2.5 to 4 wt % cis-, β-Ocimene, 0.5 to 15, more particularly 1 to 3, wt % trans-, β-Ocimene, 1 to 45, more particularly 5.5 to 7, wt % lavandulyl acetate, and 1 to 30, more particularly 7 to 8, wt % trans-, β-farnesene, based on the total weight of the co-extract.

Table 2 below lists the compounds found in an example of L. angustifolia/S. sclarea co-extract essential oil.

TABLE 2
Identity of the volatile fraction contained in
Lavandula angustifolia + Salvia sclarea EOs.

| | | MS | LRI | LRI | Area | RSD |
|---|---|---|---|---|---|---|
| ID | Compounds | Sim % | exp | lib | % | (%) |
| 1 | Tricyclene | 92 | 924 | 923 | 0.02 | 3.53 |
| 2 | α-Thujene | 97 | 926 | 927 | 0.04 | 1.33 |
| 3 | α-Pinene | 97 | 934 | 933 | 0.17 | 0.34 |
| 4 | Camphene | 96 | 950 | 953 | 0.13 | 0.46 |
| 5 | Sabinene | 97 | 973 | 972 | 0.26 | 0.45 |
| 6 | β-Pinene | 88 | 978 | 978 | 0.13 | 0.87 |
| 7 | Vinyl amyl carbinol | 96 | 980 | 978 | | |
| 8 | Octan-3-one | 96 | 984 | 986 | 0.26 | 0.38 |
| 9 | Myrcene | 98 | 989 | 991 | 0.83 | 0.46 |
| 10 | butyl-Butanoate | 98 | 995 | 999 | 0.02 | 0.00 |
| 11 | Octan-3-ol | 98 | 997 | 999 | 0.06 | 0.94 |
| 12 | cis-, dehydro-Linalool | 92 | 1005 | 1006 | 0.01 | 10.83 |
| | oxide | | | | | |
| 13 | α-Phellandrene | 91 | 1007 | 1007 | 0.03 | 5.95 |
| 14 | δ-3-Carene | 96 | 1010 | 1009 | 0.18 | 0.00 |
| 15 | hexyl-Acetate | 91 | 1011 | 1012 | | |
| 16 | α-Terpinene | 96 | 1018 | 1018 | 0.05 | 2.08 |
| 17 | o-Cymene | 90 | 1020 | 1024 | 0.05 | 1.19 |
| 18 | p-Cymene | 97 | 1025 | 1025 | 0.28 | 0.41 |
| 19 | Limonene | 96 | 1030 | 1030 | 0.38 | 0.46 |
| 20 | β-Phellandrene | 94 | 1032 | 1031 | 0.44 | 0.13 |
| 21 | Eucalyptol | 93 | 1033 | 1032 | | |
| 22 | cis-, β-Ocimene | 91 | 1035 | 1035 | 3.21 | 0.34 |
| 23 | trans-, β-Ocimene | 97 | 1046 | 1046 | 2.07 | 0.32 |
| 24 | γ-Terpinene | 96 | 1059 | 1058 | 0.14 | 0.42 |
| 25 | cis-Sabinene hydrate | 93 | 1071 | 1069 | 0.04 | 6.46 |
| 26 | m-Cymenene | 88 | 1082 | 1080 | 0.02 | 0.00 |
| 27 | Terpinolene | 94 | 1087 | 1086 | 0.18 | 0.31 |
| 28 | p-Cymenene | 95 | 1092 | 1093 | 0.06 | 11.06 |
| 29 | Linalool | 98 | 1101 | 1101 | 19.87 | 0.33 |
| 30 | 3-acetoxy-Octene | 96 | 1107 | 1109 | 0.41 | 1.01 |
| 31 | 3-octyl-Acetate | 95 | 1119 | 1120 | 0.05 | 2.17 |
| 32 | cis-, p-Menth-2-en-1-ol | 87 | 1126 | 1124 | 0.02 | 17.32 |
| 33 | (4-trans, 6-cis)- | 90 | 1129 | 1128 | 0.67 | 0.31 |
| | Allocimene | | | | | |
| 34 | hexyl-Isobutyrate | 95 | 1147 | 1150 | 0.02 | 0.00 |
| 35 | Camphor | 98 | 1149 | 1149 | 0.25 | 0.23 |
| 36 | Lavandulol | 96 | 1165 | 1165 | 1.15 | 0.36 |
| 37 | Borneol | 98 | 1175 | 1173 | 1.58 | 0.19 |
| 38 | Terpinen-4-ol | 92 | 1183 | 1184 | 3.83 | 0.26 |
| 39 | p-Cymen-8-ol | 87 | 1188 | 1189 | 0.40 | 0.29 |
| 40 | Cryptone | 93 | 1190 | 1187 | | |
| 41 | hexyl-Butyrate | 97 | 1191 | 1195 | 0.21 | 1.29 |
| 42 | α-Terpineol | 98 | 1198 | 1195 | 3.25 | 0.39 |
| 43 | trans-Carveol | 94 | 1222 | 1223 | 0.07 | 14.50 |
| 44 | Nerol | 98 | 1226 | 1229 | 0.97 | 0.61 |
| 45 | Bornyl formate | 95 | 1231 | 1230 | 0.15 | 2.19 |
| 46 | Neral | 96 | 1240 | 1238 | 0.03 | 0.00 |
| 47 | Cuminaldehyde | 99 | 1245 | 1243 | 0.29 | 0.53 |
| 48 | Carvone | 92 | 1247 | 1246 | 0.10 | 1.16 |
| 49 | Linalyl acetate | 98 | 1251 | 1250 | 12.88 | 0.66 |
| 50 | Geraniol | 98 | 1253 | 1255 | 2.96 | 0.29 |
| 51 | Geranial | 97 | 1270 | 1268 | 0.04 | 3.53 |
| 52 | Isopulegyl acetate | 87 | 1272 | 1273 | 0.05 | 2.04 |
| 53 | Phellandral | 98 | 1281 | 1277 | 0.28 | 1.07 |
| 54 | Lavandulyl acetate | 98 | 1284 | 1284 | 6.25 | 0.90 |
| 55 | Bornyl acetate | 98 | 1286 | 1285 | 0.37 | 8.73 |
| 56 | α-Terpinen-7-al | 90 | 1290 | 1287 | 0.05 | 1.12 |
| 57 | p-Cymen-7-ol | 92 | 1295 | 1291 | 0.14 | 0.71 |
| 58 | hexyl-Tiglate | 96 | 1329 | 1329 | 0.05 | 5.38 |
| 59 | α-Terpinyl acetate | 94 | 1348 | 1349 | 0.07 | 0.00 |
| 60 | cis-Geranyl acetate | 98 | 1359 | 1361 | 2.14 | 0.33 |
| 61 | trans-Geranyl acetate | 97 | 1378 | 1380 | 4.70 | 0.31 |
| 62 | hexyl-Hexanoate | 96 | 1385 | 1390 | 0.10 | 0.55 |
| 63 | 7-epi-Sesquithujene | 95 | 1389 | 1387 | 0.13 | 3.01 |
| 64 | β-Cubebene | 92 | 1390 | 1392 | 0.11 | 4.36 |
| 65 | α-Funebrene | 96 | 1404 | 1403 | 0.06 | 4.22 |
| 66 | cis-, α-Bergamotene | 97 | 1415 | 1416 | 0.10 | 5.36 |
| 67 | α-Santalene | 96 | 1421 | 1418 | 9.94 | 0.36 |
| 68 | trans-Caryophyllene | 98 | 1424 | 1424 | | |
| 69 | β-Copaene | 88 | 1433 | 1433 | 0.04 | 7.53 |
| 70 | trans-, α-Bergamotene | 97 | 1435 | 1432 | 0.31 | 1.23 |
| 71 | α-Himachalene | 88 | 1446 | 1449 | 0.14 | 19.32 |
| 72 | epi-, β-Santalene | 96 | 1449 | 1446 | 0.11 | 20.74 |
| 73 | trans-, β-Farnesene | 97 | 1454 | 1452 | 7.41 | 0.62 |
| 74 | α-Humulene | 97 | 1459 | 1454 | 0.39 | 5.85 |
| 75 | cis-Muurola-4(14),5-diene | 93 | 1466 | 1466 | 0.06 | 22.32 |
| 76 | Germacrene D | 94 | 1485 | 1480 | 0.72 | 0.42 |
| 77 | trans-, β-Bergamotene | 94 | 1486 | 1483 | 0.15 | 0.39 |
| 78 | Bicyclogermacrene | 95 | 1499 | 1497 | 0.05 | 4.90 |
| 79 | trans, trans-, | 94 | 1505 | 1504 | 0.08 | 9.16 |
| | α-Farnesene | | | | | |
| 80 | β-Bisabolene | 90 | 1509 | 1508 | 0.10 | 11.43 |
| 81 | β-Curcumene | 91 | 1511 | 1511 | 0.04 | 3.94 |
| 82 | γ-Cadinene | 97 | 1517 | 1512 | 0.78 | 0.86 |
| 83 | Caryophyllene oxide | 96 | 1587 | 1587 | 1.88 | 2.30 |
| 84 | α-Muurolol | 90 | 1647 | 1651 | 0.87 | 0.27 |
| 85 | Phytone | 95 | 1841 | 1841 | 0.06 | 0.96 |

| | | | | | |
|---|---|---|---|---|---|
| Not identified | — | — | — | 4.00 | 6.39 |
| Total | — | — | — | 100.00 | — |

Abbreviations: LRI exp: experimental LRI; LRI ref: reference LRI; MS Sim %: database spectral similarity; RSD: relative standard deviation. The volatile compounds are expressed in % values.

A further component of blend A, and a component of blend B, is a Gaultheria fragrantissima essential oil. An example of a G. fragrantissima essential oil is commercially available from Eden Botanicals. In one embodiment, the Gaultheria fragrantissima essential oil includes methyl salicylate (98-99.6%) and ethyl salicylate (0.1-0.5%), based on the total weight of the Gaultheria fragrantissima essential oil.

Another component of blend B is a Coriandrum sativum essential oil. In certain examples, the C. sativum essential oil is extracted from seeds of C. sativum variety from Bulgaria. In one embodiment, the C. sativum essential oil includes 10 to 70, more particularly 53 to 54, wt % linalool, and 1 to 20, more particularly 3 to 4, wt % linalyl acetate, based on the total weight of the composition. Table 3 below list the compounds found in an example of a C. sativum essential oil.

TABLE 3
Identity of the volatile fraction contained
in Coriandrum sativum EOs.

| | | MS | LRI | LRI | Area | RSD |
|---|---|---|---|---|---|---|
| ID | Compounds | Sim % | exp | lib | % | (%) |
| 1 | Diacetone alcohol | 98 | 836 | 834 | 1.13 | 0.42 |
| 2 | α-Pinene | 97 | 934 | 933 | 0.28 | 0.91 |
| 3 | Camphene | 95 | 950 | 953 | 0.08 | 2.53 |
| 4 | 6-methyl-Hept-5-en-2-one | 96 | 984 | 986 | 0.06 | 1.98 |
| 5 | Myrcene | 89 | 989 | 991 | 0.06 | 9.72 |
| 6 | 6-methyl-Hept-5-en-2-ol | 94 | 993 | 995 | 0.02 | 7.51 |
| 7 | α-Phellandrene | 95 | 1007 | 1007 | 0.07 | 5.38 |
| 8 | p-Cymene | 98 | 1025 | 1025 | 3.54 | 1.13 |
| 9 | Limonene | 93 | 1030 | 1030 | 0.68 | 1.40 |
| 10 | γ-, γ-vinyl- | 98 | 1038 | 1035 | 0.29 | 0.53 |
| | Valerolactone | | | | | |
| 11 | cis-Arbusculone | 96 | 1050 | 1049 | 0.04 | 7.35 |
| 12 | cis-Linalool oxide | 98 | 1072 | 1069 | 3.05 | 0.30 |
| 13 | trans-Linalool oxide | 97 | 1088 | 1086 | 2.85 | 0.40 |
| 14 | Heptyl methyl ketone | 95 | 1091 | 1093 | 0.05 | 2.85 |
| 15 | Linalool | 99 | 1103 | 1101 | 53.23 | 0.23 |
| 16 | 3-acetoxy-Octene | 93 | 1108 | 1109 | 0.07 | 9.89 |
| 17 | Camphor | 98 | 1150 | 1149 | 3.01 | 0.28 |
| 18 | Lavandulol | 96 | 1165 | 1165 | 0.31 | 1.31 |
| 19 | cis-Pyran linalool oxide | 97 | 1172 | 1169 | 0.60 | 1.18 |
| 20 | Borneol | 92 | 1174 | 1173 | 0.44 | 1.49 |
| 21 | trans-Pyran linalool oxide | 98 | 1177 | 1174 | 0.59 | 0.35 |
| 22 | Terpinen-4-ol | 90 | 1183 | 1184 | 0.41 | 1.40 |
| 23 | p-Cymen-8-ol | 91 | 1189 | 1189 | 2.16 | 0.38 |
| 24 | hex-(3cis)-enyl-Butyrate | 89 | 1190 | 1187 | | |
| 25 | α-Terpineol | 97 | 1197 | 1195 | 0.91 | 0.11 |
| 26 | Neral | 98 | 1240 | 1238 | 0.11 | 3.30 |
| 27 | Carvone | 97 | 1247 | 1246 | 0.33 | 0.46 |
| 28 | Linalyl acetate | 98 | 1250 | 1250 | 3.57 | 0.12 |
| 29 | Geraniol | 98 | 1252 | 1255 | 0.78 | 2.99 |
| 30 | Geranial | 97 | 1270 | 1268 | 0.21 | 7.11 |
| 31 | 3,7-dimethyl-Octa-1,7- | 93 | 1274 | 1271 | 0.41 | 5.85 |
| | dien-3,6-diol | | | | | |
| 32 | Lavandulyl acetate | 98 | 1284 | 1284 | 1.26 | 1.35 |
| 33 | Bornyl acetate | 96 | 1286 | 1285 | 0.13 | 6.47 |
| 34 | Geranyl formate | 97 | 1298 | 1300 | 0.15 | 3.84 |
| 35 | cis-Geranyl acetate | 98 | 1359 | 1361 | 0.64 | 1.59 |
| 36 | trans-Geranyl acetate | 97 | 1378 | 1380 | 2.21 | 1.17 |
| 37 | hexyl-Hexanoate | 88 | 1385 | 1390 | 0.27 | 5.46 |
| 38 | α-Santalene | 94 | 1421 | 1418 | 0.32 | 4.17 |
| 39 | 8-hydroxy-Carvotanacetone | 90 | 1432 | 1428 | 0.15 | 3.41 |
| 40 | α-Curcumene | 94 | 1482 | 1480 | 0.13 | 3.81 |
| 41 | p-, (1S,2S,4S)-Menthane- | 94 | 1492 | 1488 | 0.11 | 4.09 |
| | 1,2,4-triol | | | | | |
| 42 | γ-Cadinene | 94 | 1517 | 1512 | 0.35 | 1.60 |
| 43 | Caryophyllene oxide | 96 | 1587 | 1587 | 0.76 | 1.00 |
| 44 | Caryophylla-4(12),8(13)- | 89 | 1643 | 1642 | 0.43 | 1.11 |
| | dien-5-alpha-ol | | | | | |
| 45 | α-Muurolol | 91 | 1647 | 1651 | 0.39 | 6.94 |
| 46 | Phytone | 95 | 1841 | 1841 | 0.17 | 1.45 |

| | | | | | |
|---|---|---|---|---|---|
| Not identified | — | — | — | 13.21 | 0.86 |
| Total | — | — | — | 100.00 | — |

Abbreviations: LRI exp: experimental LRI; LRI ref: reference LRI; MS Sim %: database spectral similarity; RSD: relative standard deviation. The volatile compounds are expressed in % values.

One component of blend C, and blend E, is Carum carvi (carraway) supercritical CO₂ extracted essential oil. In certain examples, the Carum carvi is a variety from the European Union. In certain embodiments, the C. carvi is extracted via supercritical extraction with CO₂. In certain embodiments, the C. carvi extract includes:
50-75 wt % (S)-(+)-carvone, more particularly 45-53 wt %; and
25-55 wt % limonene, more particularly 44-49.9 wt %,
based on the total weight of the Carum carvi (carraway) supercritical CO₂ extracted essential oil.

Another component of blend C, and blend D, and blend E, is Cymbopogon martinii (palmarosa) essential oil. In certain embodiments, the Cymbopogon martinii (palmarosa) essential oil is steam distilled. In certain examples, the C. martinii is a variety from India. In certain embodiments, the C. martinii includes:
10 to 90 vol %, more particularly 79.9 vol %, geraniol;
5 to 45 wt %, more particularly 4 to 12 wt %, geranyl acetate;
5 to 45 wt %, more particularly 8 to 11 wt %, linalool; and
0.5 to 15 wt %, more particularly 8 to 11 wt %, beta-caryophyllene,
based on the total weight and total volume of the Cymbopogon martinii (palmarosa) essential oil.

A further component of blend C, and blend D, and blend E, is Aniba rosaeodora essential oil. In certain embodiments, the Aniba rosaeodora is steam distilled essential oil from the leaves and twigs of this species. In certain examples, the Aniba rosaeodora is a variety from Brazil. In certain embodiments, the Aniba rosaeodora includes:
10 to 99 vol %, more particularly 89 vol %, linalool;
0.5 to 5 vol %, more particularly 1.24 vol %, alpha-terpineol;
0.5 to 5% vol %, more particularly 1.24 vol %, beta-selinene; and
0.5 to 5%, more particularly 1.04 vol %, alpha-copaene,
based on the total volume of the Aniba rosaeodora essential oil.

An additional component of blend C, and blend D, and blend E, is Prunus armeniaca essential oil. In certain embodiments, the Prunus armeniaca is hydrodistilled essential oil from the nuts and kernels of this species. In certain examples, the Prunus armeniaca is a variety from Morocco. In certain embodiments, the Prunus armeniaca includes:
10 to 99.9 vol %, more particularly 99 vol %, benzaldehyde;
0.5 to 5 vol %, more particularly 1.24 vol %, benzyl alcohol; and
0.09 to 4 vol %, more particularly 0.13 vol %, ethyl-benzoate,
based on the total volume of the Prunus armeniaca essential oil.

A further component of blend D and blend E is Citrus aurantium subsp. bigaradia (neroli) essential oil. In certain examples, the Citrus aurantium subsp. bigaradia is a variety grown in Egypt. In certain embodiments, the Citrus aurantium subsp. bigaradia essential oil includes the following components:
10 to 99 vol %, more particularly 40-50% vol %, linalool;
10 to 99 vol %, more particularly 5-15% vol %, linalyl acetate;
1 to 20 vol %, more particularly 5-7% vol %, alpha-terpineol;
1 to 15 vol %, more particularly 3-5% vol %, geraniol; and
10 to 99 vol %, more particularly 3 to 5 vol %, geranyl acetate,
based on the total volume of the Citrus aurantium subsp. bigaradia essential oil.

Several embodiments are described below in the following numbered paragraphs:
1. A composition comprising a blend of:
5 to 40 vol % Lavandula angustifolia essential oil;
5 to 40 vol % Lavandula angustifolia and Salvia sclarea co-extract essential oil; and
30 to 90 vol % Gaultheria fragrantissima essential oil,
based on the total volume of the composition.
2. A composition consisting of:
5 to 40 vol % Lavandula angustifolia essential oil;
5 to 40 vol % Lavandula angustifolia and Salvia sclarea co-extract essential oil; and
30 to 90 vol % Gaultheria fragrantissima essential oil,
based on the total volume of the composition.
3. The composition of paragraph 1 or 2, wherein the Lavandula angustifolia essential oil comprises 5 to 55 wt % linalool, and 10 to 60 wt % linalyl acetate, based on the total weight of the Lavandula angustifolia essential oil.
4. The composition of any one of paragraphs 1 to 3, wherein the Lavandula angustifolia essential oil comprises 0.5 to 30 wt % cis-, β-Ocimene, 0.5 to 30 wt % trans-, β-Ocimene, 1 to 45 wt % lavandulyl acetate, and 1 to 20 wt % trans-, β-farnesene,
based on the total weight of the Lavandula angustifolia essential oil.
5. The composition of any one of paragraphs 1 to 4, wherein the Lavandula angustifolia and Salvia sclarea co-extract essential oil comprises 5 to 60 wt % linalool, and 5 to 55 wt % linalyl acetate,
based on the total weight of the Lavandula angustifolia and Salvia sclarea co-extract essential oil.
6. The composition of any one of paragraphs 1 to 5, wherein the Lavandula angustifolia and Salvia sclarea co-extract essential oil comprises 0.5 to 15 wt % cis-, β-Ocimene, 0.5 to 15 wt % trans-, β-Ocimene, 1 to 45 wt % lavandulyl acetate, and 1 to 30 wt % trans-, β-farnesene,
based on the total weight of the Lavandula angustifolia and Salvia sclarea co-extract essential oil.
7. The composition of any one of paragraphs 1 to 6, wherein the Gaultheria fragrantissima essential oil comprises 98 to 99.6 wt % methyl salicylate, based on the total weight of the composition.
8. The composition of paragraph 1, wherein the composition comprises 18 vol % Lavandula angustifolia essential oil, 15 vol % Lavandula angustifolia and Salvia sclarea co-extract essential oil, and 67 vol % Gaultheria fragrantissima essential oil.
9. A composition comprising a blend of:
30 to 95 vol % Gaultheria fragrantissima essential oil; and
5 to 55 vol % Coriandrum sativum essential oil,
based on the total volume of the composition.
10. A composition consisting of:
30 to 95 vol % Gaultheria fragrantissima essential oil; and
5 to 55 vol % Coriandrum sativum essential oil,
based on the total volume of the composition.
11. The composition of paragraph 9 or 10, wherein the Gaultheria fragrantissima essential oil comprises 98 to 99.6 wt % methyl salicylate, based on the total weight of the Gaultheria fragrantissima essential oil.
12. The composition of any of paragraphs 9 to 11, wherein the Coriandrum sativum essential oil comprises 5 to 55 wt % linalool, and 10 to 60 wt % linalyl acetate, based on the total weight of the Coriandrum sativum essential oil.
13. The composition of paragraph 9, wherein the composition comprises 78 vol % Gaultheria fragrantissima essential oil and 22 vol % Coriandrum sativum essential oil.
14. A composition comprising a blend of Carum carvi CO₂ extracted essential oil; Cymbopogon martinii essential oil; Aniba rosaeodora essential oil; and Prunus armeniaca essential oil.
15. The composition of paragraph 14 comprising a blend of:
4 to 55 vol % Carum carvi CO₂ extracted essential oil;
5 to 50 vol % Cymbopogon martinii essential oil;
5 to 45 vol % Aniba rosaeodora essential oil; and
5 to 55 vol % Prunus armeniaca essential oil,
based on the total volume of the composition.
16. A composition consisting of:
4 to 55 vol % Carum carvi CO₂ extracted essential oil;
5 to 50 vol % Cymbopogon martinii essential oil;
5 to 45 vol % Aniba rosaeodora essential oil; and
5 to 55 vol % Prunus armeniaca essential oil,
based on the total volume of the composition.
17. The composition of any one of paragraphs 14 to 16, wherein the Carum carvi CO₂ extracted essential oil comprises 50-75 wt % (S)-(+)-carvone, and 25-55 wt % limonene,
based on the total weight of the Carum carvi (carraway) supercritical CO₂ extracted essential oil.
18. The composition of any one of paragraphs 14 to 17, wherein the Cymbopogon martinii essential oil comprises 10 to 90 vol % geraniol, 5 to 45 wt % geranyl acetate, 5 to 45 wt % linalool, and 0.5 to 15 wt % beta-caryophyllene,
based on the total weight and total volume of the Cymbopogon martinii (palmarosa) essential oil.
19. The composition of any one of paragraphs 14 to 18, wherein the Aniba rosaeodora essential oil comprises 10 to 99 vol % linalool, 0.5 to 5 vol % alpha-terpineol, 0.5 to 5% vol %, beta-selinene, and 0.5 to 5% alpha-copaene,
based on the total volume of the Aniba rosaeodora essential oil.
20. The composition of any one of paragraphs 14 to 19, wherein the Prunus armeniaca essential oil comprises 10 to 99.9 vol % benzaldehyde, 0.5 to 5 vol % benzyl alcohol, and
0.09 to 4 vol % ethyl-benzoate,
based on the total volume of the Prunus armeniaca essential oil.
21. The composition of paragraph 14, wherein the composition comprises:
25 vol % Carum carvi CO₂ extracted essential oil;
25 vol % Cymbopogon martinii essential oil;
25 vol % Aniba rosaeodora essential oil; and
25 vol % Prunus armeniaca essential oil,
based on the total volume of the composition.
22. A composition comprising a blend of Cymbopogon martinii essential oil; Citrus aurantium subsp. bigaradia essential oil; Aniba rosaeodora essential oil; and Prunus armeniaca essential oil.
23. The composition of paragraph 22, comprising a blend of:
6 to 50 vol % Cymbopogon martinii essential oil;
5 to 50 vol % Citrus aurantium subsp. bigaradia essential oil;
5 to 45 vol % Aniba rosaeodora essential oil; and
5 to 55 vol % Prunus armeniaca essential oil,
based on the total volume of the composition.
24. A composition consisting of:
6 to 50 vol % Cymbopogon martinii essential oil;
5 to 50 vol % Citrus aurantium subsp. bigaradia essential oil;
5 to 45 vol % Aniba rosaeodora essential oil; and
5 to 55 vol % Prunus armeniaca essential oil,
based on the total volume of the composition.
25. The composition of paragraph 23 or 24, wherein the Cymbopogon martinii essential oil comprises 10 to 90 vol % geraniol, 5 to 45 wt % geranyl acetate, 5 to 45 wt % linalool, and 0.5 to 15 wt % beta-caryophyllene,
based on the total weight and total volume of the Cymbopogon martinii essential oil.
26. The composition of any one of paragraphs 23 to 25, wherein Citrus aurantium subsp. bigaradia essential oil comprises 10 to 99 vol % linalool, 10 to 99 vol % linalyl acetate, 1 to 20 vol % alpha-terpineol, 1 to 15 vol % geraniol, and 10 to 99 vol % geranyl acetate,
based on the total volume of the Citrus aurantium subsp. bigaradia essential oil.
27. The composition of any one of paragraphs 23 to 26, wherein the Aniba rosaeodora essential oil comprises 10 to 99 vol % linalool, 0.5 to 5 vol % alpha-terpineol, 0.5 to 5% vol %, beta-selinene, and 0.5 to 5% alpha-copaene,
based on the total volume of the Aniba rosaeodora essential oil.
28. The composition of any one of paragraphs 23 to 27, wherein the Prunus armeniaca essential oil comprises 10 to 99.9 vol % benzaldehyde, 0.5 to 5 vol % benzyl alcohol, and
0.09 to 4 vol % ethyl-benzoate,
based on the total volume of the Prunus armeniaca essential oil.
29. The composition of paragraph 23, comprising a blend of:
25 vol % Cymbopogon martinii essential oil;
25 vol % Citrus aurantium subsp. bigaradia essential oil;
25 vol % Aniba rosaeodora essential oil; and
25 vol % Prunus armeniaca essential oil,
based on the total volume of the composition.
30. A composition comprising a blend of Carum carvi essential oil; Cymbopogon martinii essential oil; Citrus aurantium subsp. bigaradia essential oil; Aniba rosaeodora essential oil; and Prunus armeniaca essential oil.
31. The composition of paragraph 30, comprising a blend of:
4 to 55 vol % Carum carvi essential oil;
6 to 50 vol % Cymbopogon martinii essential oil;
6 to 45 vol % Citrus aurantium subsp. bigaradia essential oil;
5 to 45 vol % Aniba rosaeodora essential oil; and
6 to 55 vol % Prunus armeniaca essential oil,
based on the total volume of the composition.
32. A composition consisting of:
4 to 55 vol % Carum carvi essential oil;
6 to 50 vol % Cymbopogon martinii essential oil;
6 to 45 vol % Citrus aurantium subsp. bigaradia essential oil;
5 to 45 vol % Aniba rosaeodora essential oil; and
6 to 55 vol % Prunus armeniaca essential oil,
based on the total volume of the composition.
33. The composition of any of paragraphs 30 to 32, wherein the Carum carvi CO₂ extracted essential oil comprises 50-75 wt % (S)-(+)-carvone, and 25-55 wt % limonene,
based on the total weight of the Carum carvi (carraway) supercritical CO₂ extracted essential oil.
34. The composition of any one of paragraphs 31 to 33, wherein the Cymbopogon martinii essential oil comprises 10 to 90 vol % geraniol, 5 to 45 wt % geranyl acetate, 5 to 45 wt % linalool, and 0.5 to 15 wt % beta-caryophyllene,
based on the total weight and total volume of the Cymbopogon martinii (palmarosa) essential oil.
35. The composition of any one of paragraphs 31 to 34, wherein Citrus aurantium subsp. bigaradia essential oil comprises 10 to 99 vol % linalool, 10 to 99 vol % linalyl acetate, 1 to 20 vol % alpha-terpineol, 1 to 15 vol % geraniol, and 10 to 99 vol % geranyl acetate,
based on the total volume of the Citrus aurantium subsp. bigaradia essential oil.
36. The composition of any one of paragraphs 31 to 35, wherein the Aniba rosaeodora essential oil comprises 10 to 99 vol % linalool, 0.5 to 5 vol % alpha-terpineol, 0.5 to 5% vol %, beta-selinene, and 0.5 to 5% alpha-copaene,
based on the total volume of the Aniba rosaeodora essential oil.
37. The composition of any one of paragraphs 31 to 36, wherein the Prunus armeniaca essential oil comprises 10 to 99.9 vol % benzaldehyde, 0.5 to 5 vol % benzyl alcohol, and
0.09 to 4 vol % ethyl-benzoate,
based on the total volume of the Prunus armeniaca essential oil.
38. The composition of paragraph 31, comprising a blend of:
20 vol % Carum carvi essential oil;
20 vol % Cymbopogon martinii essential oil;
20 vol % Citrus aurantium subsp. bigaradia essential oil;
20 vol % Aniba rosaeodora essential oil; and
20 vol % Prunus armeniaca essential oil,
based on the total volume of the composition.
39. A method comprising mixing together:
5 to 40% vol % Lavandula angustifolia essential oil;
5 to 40% vol % Lavandula angustifolia and Salvia sclarea co-extract essential oil; and
30 to 90% vol % Gaultheria fragrantissima essential oil,
based on the total volume of the composition.
40. A method comprising mixing together:
30 to 95 vol % Gaultheria fragrantissima essential oil; and
5 to 55 vol % Coriandrum sativum essential oil,
based on the total volume of the composition.
41. A method comprising mixing together:
4 to 55 vol % Carum carvi CO₂ extracted essential oil;
5 to 50 vol % Cymbopogon martinii essential oil;
5 to 45 vol % Aniba rosaeodora essential oil; and
5 to 55 vol % Prunus armeniaca essential oil,
based on the total volume of the composition.
42. A method comprising mixing together:
6 to 50 vol % Cymbopogon martinii essential oil;
5 to 50 vol % Citrus aurantium subsp. bigaradia essential oil;
5 to 45 vol % Aniba rosaeodora essential oil; and
5 to 55 vol % Prunus armeniaca (bitter almond) essential oil,
based on the total volume of the composition.
43. A method comprising mixing together:
4 to 55 vol % Carum carvi essential oil;
6 to 50 vol % Cymbopogon martinii essential oil;
6 to 45 vol % Citrus aurantium subsp. bigaradia essential oil;
5 to 45 vol % Aniba rosaeodora essential oil; and
6 to 55 vol % Prunus armeniaca essential oil,
based on the total volume of the composition.
44. A method comprising applying any one of the compositions of paragraphs 1 to 38 to a potato, thereby suppressing potato sprouts.
45. The method of paragraph 44, wherein the potato is in storage and potato sprouts are suppressed for up to 8 months.

The essential oil blends can be delivered via various modalities. In one aspect, the blends can be delivered via a “cold” fog evaporation method. In another aspect, the blends can be delivered via a “wick” method (natural evaporation at room temperature). In another aspect, the blends can be delivered via a “hot” fog method (i.e., thermo-fogging).

Wick method: This is described in a previous publication, (Owolabi et al., 2013, https://doi.org/10.1016/j.indcrop.2012.11.043): The wick method is used at room temperature (72F), using a small amount of essential oil in glass vial covered with center-bored lid, through which a wick of 10 cm×0.3 cm made of cotton is inserted. The wick helps with the evaporation of the essential oil, and results in relatively rapid release of the essential oil. The potato tubers are exposed to the essential oil vapors, generated through this method. Usually, 8 tubers can be treated with 0.3 mL of essential oil to suppress sprouting over 2-4 weeks. The amount of essential oil evaporation depends on the concentration, temperature, and the time duration.

Cotton ball (alternative to wick) method: This method is described in Thoma et al., (2022, https://doi.org/10.3390/plants11223055): One (1) mL of essential oil is pipetted on to a cotton ball sitting in a glass Petri dish lined with filter paper in the center of 20 L plastic container with various number of tubers. Containers are then sealed with aluminum foil for fumigation with the essential oil vapor. The Petri dish with the essential oil has no direct contact with the tubers. This application method is suitable for essential oil evaporation at room and higher temperatures e.g. during long-distance potato transportation over land or sea. Observations are taken at 30 days and then repeatedly at every 15 days for up to 90 or even 250 days. The efficacy depends on the chemical profile of the specific essential oil or essential oil blend, temperature, concentration, and the duration of the treatment.

Thermal fogging (thermo-fogging) method: This fogging method has been traditionally utilized by the potato industry for application of the most common chemical isopropyl N-(3-chlorophenyl) carbamate (chlorpropham or CIPC), in potato storage over several decades. The potato industry has also been using lower storage temperatures of 8-12 C and CIPC is applied at very high temperatures, around 650F (500-750F) as its flash point is around 800 F. The CIPC is applied at rates of 1 to 2 lb of CIPC active ingredient per 1,000 bushels (600 hundred weight (CWT) of potato. Published research indicated that the sprout suppression ability of CIPC was effective at temperatures of 15° C. or below. The CIPC efficacy would decrease significantly at temperature higher than 15° C. (59° F.)”

There are also smaller research-oriented foggers. For example, the 1,4 Group Research Fogger is intended to be used as a closed-door application device depending upon the storage facility conditions. In conjunction with the Research Fogger application machine, a heat gun and air pump are required to complete a fogging application. The process works through thermal transfer of heat to the chemical (essential oil) through the fogger apparatus without direct contact with the chemical. The air pump pushes the injected chemical into the storage as fog. The chemical is applied at 3 mL per 100 lbs of potato at a rate of 1 mL per minute. The temperature is set to around 500 degrees F. (depending on the flash point of a specific essential oil). The Research Fogger is attached to the storage equipment and locked into place. The vent is opened in the storage, so pressure does not build up in the container. The storage is closed for 48 hours after an application, after which it is ventilated.

The essential oil blends can be applied to potatoes (particularly in the surrounding air around potatoes) destined for storage. In certain embodiments, the applied essential oils suppress potato sprouts for up to 8 months, more particularly up to 1-8 months depending on various factors.

The essential oil blends, particularly blends C, D and E, provide sprout suppression at room temperature as well as at temperatures lower than room temperature, which may significantly reduce the need for refrigeration. The essential oil blends may remove sprouts from already sprouting potatoes.

The experimental design of the first 3 separate experiments was Simplex Centroid experimental design with blends of 3 essential oils in each experiment. Overall, 45 different 3-way essential oil blends were assessed. Repeated measurements were taken every 30-35 days and sometimes every 15 days.

Five potato tubers were placed in each 20 L container. A Petri Dish with small amount of cotton ball was placed on the center bottom of the container. The potato tubers were placed in mesh bags hanging at around 15 cm above the Petri dish. The EOs (1 mL) were applied to the cotton in every Petri dish and the containers were covered with lids to ensure dark regime at temperature of 20-22° C. Day/night regime. The potato tubers were exposed to vapors from each of the EOs for 259 days (approximately 8.5 months). There was no direct contact between the essential oils or blends and potato tubers.

Second experiment: Following statistical analyses and predictions, two of the best treatments (essential oil blends #872 and #873) were tested in 5 L jars filled with potato. The essential oil blends were cold evaporated and measurements were taken at 28 days after application. Essential oil blends #872 and #873 completely suppressed potato sprouting, resulting in 0 (zero) sprouting per tuber. For comparison, the application of clove oil (currently the only essential oil registered for potato spout control in the U.S.) resulted in 18 to 27 sprouts per tuber. Octanol has resulted in 4.6-7 sprouts/potato tuber, while the untreated control had 42 sprouts per tuber. The results are reflected in Table 3 below.

Other possible additives for blends A, B, C, D and E include the following essential oils:
Lemongrass (Cymbopogon citratus (DC.) Stapf)
Ho wood (Cinnamomum camphora (L.) J. Presl
Sweet marjoram (Origanum majorana L.)
Cumin (Cuminum cyminum L.)
Carraway (Carum carvi L.)
Peppermint (Mentha x piperita L.)
Spearmint (Mentha spicata L.)
Menthol crystal (extracted from Mentha canadensis L.)
Citronella (Cymbopogon nardus (L.) Rendle)

### Examples

Blend A (#872) is a blend (mix) of 4 essential oils in specific vol % ratio:
18% of essential oil (Lavandula angustifolia, local variety from NW Bulgaria)
15% of essential oil blend (consisting of local varieties of Lavandula angustifolia+Salvia sclarea extracted simultaneously from a mix of two crops)
67% essential oil Gaultheria fragrantissima

Blend B (#873) is a blend (mix) of 2 essential oils in specific vol ratio:
78% Wintergreen, (Gaultheria fragrantissima Wall.)
22% Coriander seed essential oil (Coriandrum sativum L.)

TABLE 4
Inventive essential oil blend compared to clove oil,
and Octanol using cold fog method.
The longest sprout was measured in mm

| Row Labels | Replicate | Sprout length (mm) |
|---|---|---|
| Blend #872 | 1 | 0.00 |
| | 2 | 0.00 |
| | 3 | 0.00 |
| Blend #873 | 1 | 0.00 |
| | 2 | 0.00 |
| | 3 | 0.00 |
| Clove oil | 1 | 22.46 |
| (Biox C) | | |
| | 2 | 18.17 |
| | 3 | 26.75 |
| Octanol | 1 | 5.67 |
| | 2 | 4.67 |
| | 3 | 6.67 |
| untreated | 1 | 42.29 |
| control | | |
| | 2 | 42.25 |
| | 3 | 42.33 |
| Grand Total | | 13.91 |

TABLE 5
Inventive essential oil blend compared to clove oil, and Octanol
using thermal fogging application method. Measurements of potato sprout
length and number of sprouts taken 60 days after treatment.
Table 5. Inventive essential oil blend compared to clove oil, and Octanol using
thermal fogging application method. Measurements taken 60 days after treatment.

| Treatments/ | Sprout length, mm | | | | | | Number of sprouts per tuber, # | | | | | |
|---|---|---|---|---|---|---|---|---|---|---|---|---|
| replicates | R1 | R2 | R3 | R4 | R5 | Average | R1 | R2 | R3 | R4 | R5 | Average |
| Blend C (1472-1) | 0 | 0 | 5 | 2 | 2 | 1.8 | 0 | 0 | 2 | 1 | 1 | 0.8 |
| Blend C (1472-2) | 0 | 1 | 0 | 0 | 2 | 0.6 | 0 | 1 | 0 | 0 | 3 | 0.8 |
| Blend D (1474-1) | 0 | 3 | 0 | 0 | 0 | 0.6 | 0 | 1 | 0 | 10 | 0 | 0.2 |
| Blend D (1474-2) | 0 | 0 | 0 | 2 | 0 | 0.4 | 0 | 0 | 0 | 1 | 0 | 0.2 |
| Blend E (1475-1) | 18 | 0 | 0 | 0 | 2 | 4 | 10 | 0 | 0 | 0 | 3 | 2.6 |
| Blend E (1475-2) | 0 | 0 | 0 | 2 | 0 | 0.4 | 0 | 0 | 0 | 1 | 0 | 0.2 |
| Clove Oil | 32 | 13 | 52 | 34 | 31 | 32.4 | 12 | 10 | 8 | 7 | 13 | 10 |
| 1-Octanol | 1 | 4 | 7 | 1 | 2 | 3 | 3 | 3 | 7 | 1 | 1 | 3 |
| Untreated Control | 27 | 48 | 54 | 25 | 59 | 42.6 | 15 | 14 | 8 | 14 | 16 | 13 |

R1 - replicate 1
R2 - replicate 2
R3 replicate 3
R4- replicate 4
R5 - replicate 5

In view of the many possible embodiments to which the principles of the disclosed invention may be applied, it should be recognized that the illustrated embodiments are only preferred examples of the invention and should not be taken as limiting the scope of the invention.

What is claimed is:

1. A composition comprising a blend of:
5 to 40 vol % Lavandula angustifolia essential oil;
5 to 40 vol % Lavandula angustifolia and Salvia sclarea co-extract essential oil; and
5 to 90 vol % Gaultheria fragrantissima essential oil,
based on the total volume of the composition.

2. A composition comprising a blend of:
30 to 95 vol % Gaultheria fragrantissima essential oil; and
5 to 55 vol % Coriandrum sativum essential oil,
based on the total volume of the composition.

3. A composition comprising a blend of Carum carvi CO₂ extracted essential oil; Cymbopogon martinii essential oil; Aniba rosaeodora essential oil; and Prunus armeniaca essential oil.

4. The composition of claim 3 comprising a blend of:
4 to 55 vol % Carum carvi CO₂ extracted essential oil;
5 to 50 vol % Cymbopogon martinii essential oil;
5 to 45 vol % Aniba rosaeodora essential oil; and
5 to 55 vol % Prunus armeniaca essential oil,
based on the total volume of the composition.

5. A composition comprising a blend of Cymbopogon martinii essential oil; Citrus aurantium subsp. bigaradia essential oil; Aniba rosaeodora essential oil; and Prunus armeniaca essential oil.

6. The composition of claim 5, comprising a blend of:
6 to 50 vol % Cymbopogon martinii essential oil;
5 to 50 vol % Citrus aurantium subsp. bigaradia essential oil;
5 to 45 vol % Aniba rosaeodora essential oil; and
5 to 55 vol % Prunus armeniaca essential oil,
based on the total volume of the composition.

7. A composition comprising a blend of Carum carvi essential oil; Cymbopogon martinii essential oil; Citrus aurantium subsp. bigaradia essential oil; Aniba rosaeodora essential oil; and Prunus armeniaca essential oil.

8. The composition of claim 7, comprising a blend of:
4 to 55 vol % Carum carvi essential oil;
6 to 50 vol % Cymbopogon martinii essential oil;
6 to 45 vol % Citrus aurantium subsp. bigaradia essential oil;
5 to 45 vol % Aniba rosaeodora essential oil; and
6 to 55 vol % Prunus armeniaca essential oil,
based on the total volume of the composition.

9. A method comprising applying the composition of claim 1 to a potato, thereby suppressing potato sprouts.

10. The method of claim 9, wherein the potato is in storage and potato sprouts are suppressed for up to 8 months.

11. A method comprising applying the composition of claim 2 to a potato, thereby suppressing potato sprouts.

12. The method of claim 11, wherein the potato is in storage and potato sprouts are suppressed for up to 8 months.

13. A method comprising applying the composition of claim 3 to a potato, thereby suppressing potato sprouts.

14. The method of claim 13, wherein the potato is in storage and potato sprouts are suppressed for up to 8 months.

15. A method comprising applying the composition of claim 5 to a potato, thereby suppressing potato sprouts.

16. The method of claim 15, wherein the potato is in storage and potato sprouts are suppressed for up to 8 months.

17. A method comprising applying the composition of claim 7 to a potato, thereby suppressing potato sprouts.

18. The method of claim 17, wherein the potato is in storage and potato sprouts are suppressed for up to 8 months.
